(19) United States
(12) Patent Application Publication
(10) Pub. No.: US 2014/0324922 A1
(43) Pub. Date: Oct. 30, 2014

(54) MEDIA CONTENT CUSTOMIZATION SYSTEM

(71) Applicant: Neal Joseph Edelstein, Los Angeles, CA (US)

(72) Inventor: Neal Joseph Edelstein, Los Angeles, CA (US)

(73) Assignee: Hooked Digital Media, Encino, CA (US)

(21) Appl. No.: 14/331,167

(22) Filed: Jul. 14, 2014

Related U.S. Application Data
(63) Continuation-in-part of application No. 13/949,169, filed on Jul. 23, 2013.
Application No. 13/949,169 is a continuation-in-part of application No. 13/773,464, filed on Feb. 21, 2013, now Pat. No. 8,520,018.
(60) Provisional application No. 61/751,823, filed on Jan. 12, 2013.
(60) Provisional application No. 61/767,168, filed on Feb. 20, 2013.

(51) Int. Cl. G06F 17/30

(52) U.S. Cl. CPC G06F 17/30091
USPC 707/812

(57) ABSTRACT

Systems, devices, and methods for delivering and managing media whereby a first media element may comprise multiple media components and a combination of information data about a user may be used to generate customized media content. In one embodiment, the user collected information data may include information collected explicitly or implicitly. Other content may exist in alternate form and solicited user preferences may alternatively control pre-identified media components. Accordingly, media content may be customized based on user input and/or user collected information data.

### CROSS-REFERENCE TO RELATED APPLICATIONS

This application is a Continuation-In-Part of Non-Provisional patent application Ser. No. 13/949,169 filed Jul. 23, 2013, and claims priority to and the benefit of: Non-Provisional patent application Ser. No. 13/773,464 filed Feb. 21, 2013, now U.S. Pat. No. 8,520,018, Provisional Patent Application No. 61/751,823 filed Jan. 12, 2013, and Provisional Patent Application No. 61/767,168 filed Feb. 20, 2013, the contents of which, including all appendices, are hereby incorporated by reference herein for all purposes.

### TECHNICAL FIELD

Embodiments relate generally to systems for customizing media content. More specifically, the present disclosure relates to systems for customizing experienced digital content and providing a solution that, in a controlled and determinable way, allows and denies access to content based on a plurality of factors. For example, customization of content may depend on a plurality of factors including implicit and explicit user activity, media host instructions, and other variables including time, location, and determined user characteristics.

### BACKGROUND

Customizing media content allows for viewing or experiencing media content in a manner inconsistent with, and in derogation to, the wishes of the artist. To remedy this, it may be desirable to control the manner in which media content is accessed. In addition, the artist may wish to customize content to increase its desirability to a user.

### SUMMARY

In one embodiment, the media content customization system may comprise a device configured to provide customized media content to a user. The content may be customized, in this case, by capturing user behavior, and tailoring content to more closely fit the user's tastes and desires. By way of a non-limiting example, media content duration may be tailored for a train commute. For example, a user who takes a thirty-five minute train ride may desire content having a duration tailored to be completed over the course of a single thirty-five minute period. In order to learn the user preferences, data may be captured in two separate ways, active capture and passive capture. In an embodiment of the active capture, the user may specify the desired duration, or select from a selection of durations. In the passive mode embodiment, a combination of time and location data may be used to create a profile for the user. The profile may, for example, take into account location, speed or travel, time of access, and time to terminate access. Location may be determined using global position systems, triangulation, or proximity to identifiable networks or other now known, or later discovered, means of identifying location. The user preferences may be derived from the user profile and stored in a database. In addition, the mental state of a user may be surmised by monitoring the user interface including such things as the frequency that a specific key is struck; and patterns in which keys are struck. For instance, repeatedly striking the same key may show impatience. A fast forward key, in the case of video content, that is repeatedly struck, might suggest that the user is bored or in a rush. Rewinding to play a scene over and over again similarly may suggest that the content is liked.

In another embodiment, the media content customization system may provide a data record module that records positional data and access data, accesses termination data in a local database, and may further include a transmission component that transmits the recorded positional and access data when the device is again capable of contact with the user profile database. In another embodiment, user stated interests are considered, that is, if a user marks a portion of media content and conveys to others that the user likes or dislikes the marked portion, that type of content may be limited or eliminated from that specific user's profile thereafter.

An exemplary device embodiment may comprise: a media content determining component configured to: receive media content from a media content database for viewing by a user, where the media content may comprise a set of one or more gaps and a set of one or more parallel paths; determine the set of one or more parallel paths based on availability of default content, where the default content may be determined based on received input from the user; determine the set of one or more gaps based on availability of custom content, where the custom content may be determined based on collected information associated with the user; and generate a customized media content based on the received media content, the determined set of one or more parallel paths, and the determined the set of one or more gaps. In one embodiment, the default content may be determined based on at least one of: add a portion of media content selected from a parallel path database to the media content, and delete a selected portion of the media content. In another embodiment, the custom content may be determined based on at least one of: fixed factors, quasi fixed factors, quasi variable factors, and variable factors. The exemplary device may also generate customized media content via determining if a preference is selected, conform the media content based on the received input from the user, and if information is collected, insert the portion of media content based on the collected information associated with the user. Optionally, the set of one or more gaps may be retrieved from a gap database and the set of one or more parallel paths may be retrieved from a parallel path database. In one embodiment, a portion of the media content is temporarily removed from the media content based on input from a user, and where input from the user adds new content to the media content. In another embodiment, the device may further be configured to: aggregate information about the user, and classify the information according to a rule set. The exemplary device may be further configured to create substantially linear media presentations based on the parallel paths and gaps.

### BRIEF DESCRIPTION OF THE DRAWINGS

Embodiments are illustrated by way of example and not limitation in the figures of the accompanying drawings, and in which:

FIG. 1 is a graphical representation of how content is customized in an embodiment of the media content customization system;

FIG. 2 is an exemplary embodiment of a computing system that includes a computing device and a content provider;

FIG. 3 is an example of an interface that a user may access for the purpose of controlling predetermined media content components;

FIG. 4 is a listing of some of the variables that may go into the selection of content for delivery;

FIG. 5 is an exemplary embodiment of a computing system that depicts a set of computing devices connected through a communication medium;

FIG. 6 is a flowchart of an exemplary process for determining customized media content; and

FIG. 7 is a flowchart of another exemplary process for determining customized media content.

### DETAILED DESCRIPTION

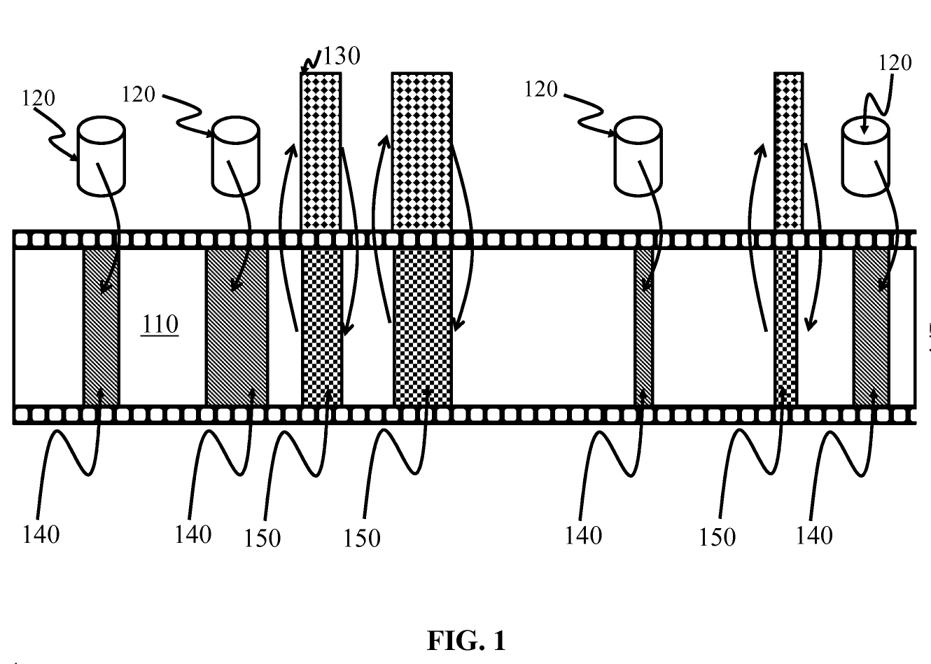

FIG. 1 depicts a graphical representation of an exemplary digital media content 110, for example, being transmitted via an electronic medium. In the media content 110 there are one or more gaps 140, the gaps 140 may be defined as areas where content is absent, or default content is present. In operation, the media content customization system, method, and devices, may insert customized content, from a database 120 comprising custom content, into the gaps 140. The database 120 comprising custom content may be queried and populated based on user or viewer collected preferences. In addition, there may be a set of one or more parallel paths 130 with significantly less customization where a set of default content 150 may be calculated and determined to appeal to the target audience. That is, the content inserted via the parallel paths 130 may be preselected and inserted based on, for example, geographical data, parental controls, or member status, where the parallel paths 130 may be preexistent. The level of customization in the parallel path 130 may be significantly less granular and may include adding or deleting content, for example: explicit content, coarse language, especially frightening scenes, crude humor, or other content which may be deleted for reasons less directly tied to audience preferences and more tied to parental controls, location and venue viewed where content is being viewed, e.g., viewing in a public space, or tied to a desire not to be exposed to certain content types. The parallel paths 130 component differs from customized content in that the content classes excluded, or included, are specifically selected by a user; where it is understood that the user need not necessarily be the viewer.

In one embodiment, the media content customization system may, via using a plurality of devices, edit the media content 110 for delivery, where the editing may be used to generate customized content 120 for a user, and may be based on selecting a customized content or parallel path content. In this embodiment, a database 120 may comprise custom content informed by viewer preferences and a portion of media content 130 may be informed by geography, parental controls, or status and inserted into a location 140 that may be ready to accept custom content, and absent any preference, default content may optionally be present. The portion of media content 130 available may be located at specified locations 150 and content may be inserted at those locations 150, where this signifies a content that is not from a database with vast variables but likely a database with a single variable.

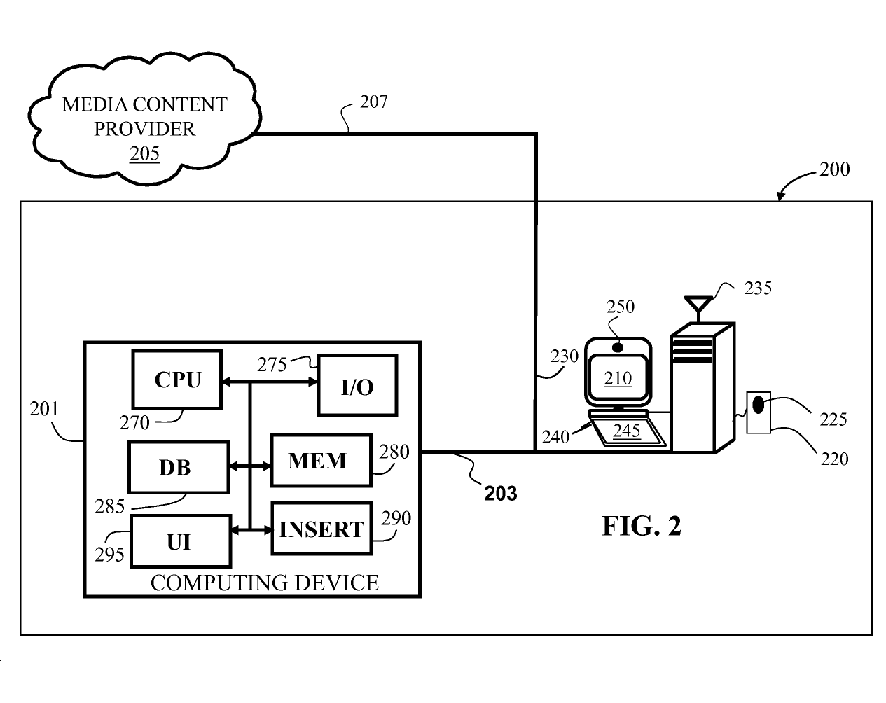

FIG. 2 illustrates an embodiment of the media content customization system, as having a computing device 200 where the computing device 200 may comprise a visual display interface 210, an auditory interface 220, a communication interface 230, a user interface 240, an electromagnetic radiation responsive component 250, and a preference selector controller 201. In some embodiments the visual display interface 210 may be configured to support the emission of electromagnetic radiation. In some embodiments, the computing device 200 may include an auditory interface 220 that may be configured to support the emission of audio signals in the form of electromechanical radiation. Optionally, the auditory interface 220 may comprise an electromechanical radiation responsive component 225.

In one embodiment, the communication interface 230 may be configured to transmit and receive electronic signals, including signals from a wire or wireless source. FIG. 2 shows an embodiment with a wireless communication interface 235. The exemplary embodiment may be configured to receive and transmit signals, including user provided data related to taste, preferences, activity level, degree of mobility, payment information, peer leadership position, physical and geographic information, and other information including certain behavioral characteristics.

In some embodiments the user interface 240 may include a tactile responsive component 245. In one embodiment this may be a standard keyboard, and/or pointer-mouse system and/or a touch screen 245. In one embodiment, the electromagnetic radiation responsive component 250 may be presented. The electromagnetic radiation responsive component 250 may be configured to receive electromagnetic radiation and convert the received electromagnetic radiation to an electronic signal which may be processed or stored, or stored and subsequently processed, or processed and stored, or some combination thereof.

In one embodiment, the computing device 200 may include a central processing unit (CPU), e.g., a processor 270, where the processor 270 may be configured to undertake a plurality of operations, as discussed herein, including signal processing and execution of instructions derived from the signal processing. Additionally, embodiments may also include an addressable memory 280, for example, read only memory (ROM) or random access memory (RAM), a data store, e.g., data base 285, a time measuring device 290, and an input/output interface 275. In one exemplary embodiment, the general handling of data, processing of data, and communication and display of data may be handled at the CPU level of the computing device by an operating system. In other embodiments the communication interface 230 may be configured to receive media content 207 from a media content provider 205. The display interface 210 is, in some embodiments, configured to display at least a portion of the media content where the downloading, streaming, and progressive downloading of the media content distribution may be done via unidirectional multicasting or broadcasting for wireless environments.

In one embodiment the preference selector controller 201 may include a component configured to receive an input from the user via the user interface 240 and may conform the media content to a set of received binary selections. In some embodiments, the preference selector controller 201 may further include a user input processor 295. The user input processor component 295 may include a rule set, based on which, received user input, or other collected user preferences, may be arranged according to the rule set. Additionally, in some embodiments, an insertion component 290 may be included. This may be locally maintained, non-locally maintained, or locally maintained and non-locally updated. An exemplary embodiment may specifically include a gap database (not shown) and a parallel path database (not shown) where the insertion component 290 may be able to extract a portion of media content from and insert into a set of one or more gaps. In some embodiments the preference selector controller 201 may be configured to select content based on a received input and control delivery of a portion of the media content based on at least one of: an active capture, i.e., input from the user interface 240; a passive capture, i.e., an input from the communication interface 230; and a set of instructions from the addressable memory 280 that may be based on fixed factors, quasi fixed factors, quasi variable factors, and variable factors. Optionally, an embodiment may comprise a position determining component where position may be determined by a terrestrially based or satellite based position determining component. In other embodiments a hybrid of terrestrially and satellite based position determining devices may be utilized, or even a hybrid of terrestrial systems or a hybrid of satellite based systems.

In the embodiment of the media content customization system 200, the preference selector controller 201 may be configured to use default content by adding or deleting content based on a set of instructions received from the processor 270; and the processor 270 may further be configured to store a set of instructions based on information collected from and about a user or viewer. The information may be collected based on a computing device identifying an accessible wireless network and accessing publically available information about the user via the Internet. This would have application where a set of information is stored in a database pending linking to the Internet or other distributed databases. This would have specific application where if no information is received from outside sources, the default content may be selected based on available parallel path content derived from locally available information. In another embodiment, the computing device 200 may be interfaced with an Internet connection when the computing device 200 comes in contact with another component capable of receiving and retransmitting signals from the computing device. In this situation the computing device may rely on a node to capture and re-convey data to a distributed database such as the Internet.

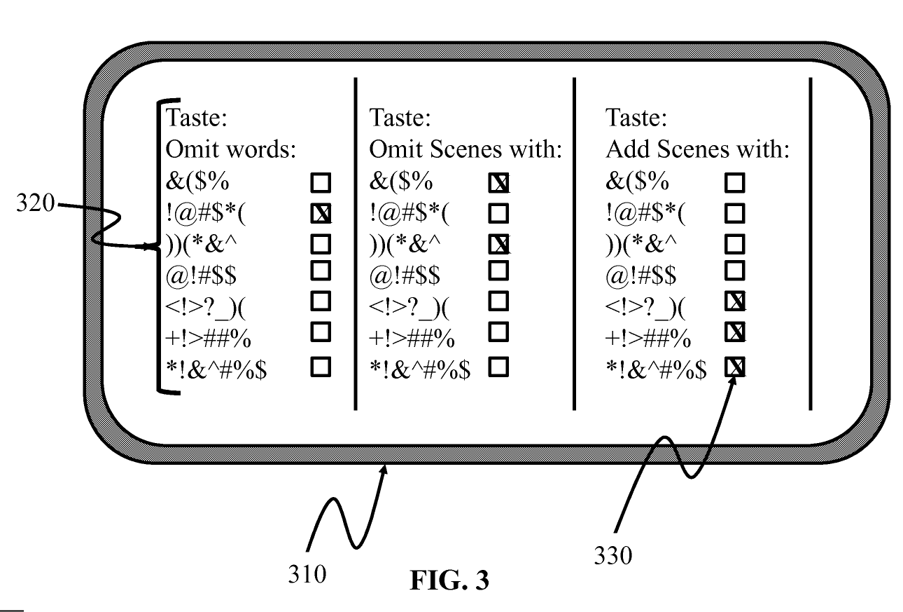

FIG. 3 depicts a variant of the media content customization system and the manner in which the system may capture preferred parallel paths 130. Specifically, in this exemplary embodiment, the user (and/or viewer) may be queried on a graphical user interface 310 of a device to select what content should be omitted or included 320. In this embodiment, the user may select, by selecting a check box 330, in order to identify specific words or content that is desired to be excluded or included. In this exemplary embodiment, the default content 150 may remain unchanged absent instructions to the contrary. Additionally, the selections may be done in a binary manner, that is, each choice may be accompanied by a corresponding user input selector where the user is given a choice or decision so the system may then determine an associated set of content to fill the gaps 140.

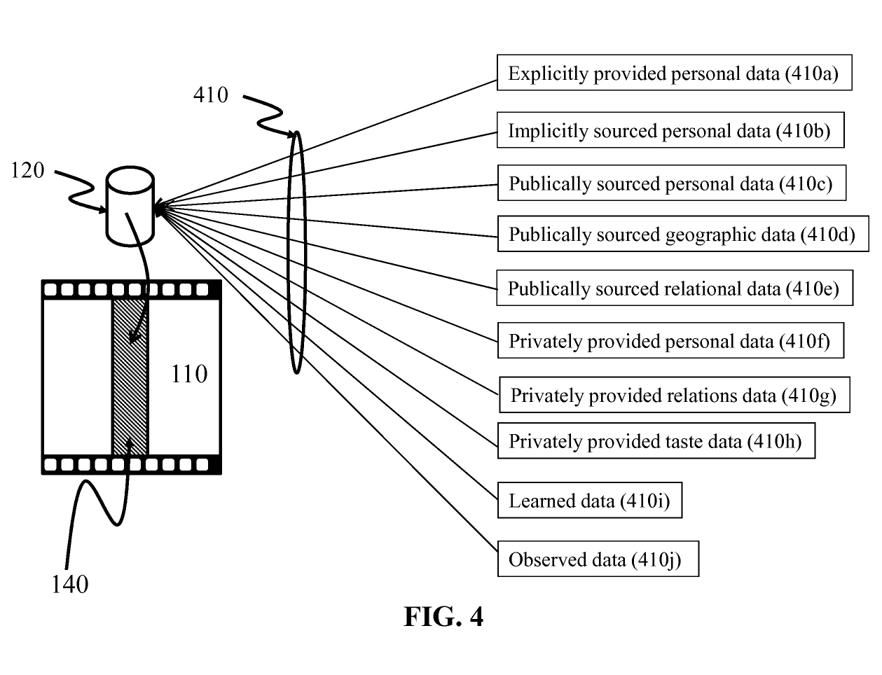

FIG. 4 depicts a more detailed view of the database 120 comprising the customized content and specifically addresses the collection of customized content. In this embodiment, various ways of selecting customized content are enumerated in data sources 410.

Explicitly provided data 410a, for example, may include data that the user explicitly provides. This data is known to be fraught with inaccuracies and may be tailored to comport with observed practices. This data may be collected in a formal questionnaire provided to the user.

Implicitly sourced personal data 410b, as another example, may include data that is collected implicitly, as by replaying portions of a show, or by a demonstrated lack of interest. For instance, if a portion of content is repeatedly paused this may be a sign that the user is interested but is distracted. Similarly, implicitly sourced personal data 410b may be based on, for example, if there is significant background noise, if no user intervention—even when requested—is present, or if there is a change in viewing behavior, where normally the user makes comments as the movie progresses and now is not making any comments.

Publically sourced personal data 410c is another example that may include data that the user makes public and that is aggregated to customize content requests for information on rattlesnakes, postings on social media, appearances in the news media, blogosphere, or other sources that are publically available.

Publically sources geographic data 410d is another example that may include data such as city of residence, preferred vacation spots, locations that user is familiar with through research or other geographical areas that are connected to the user. In addition, the user's views of the area (like, dislike) as well as landmarks or other matters of significance are ideally captured. Although, not public, the GPS locator—if enabled—may provide location information as well as commute information.

Publically sourced relational data 410e may include affinity diagrams, public records of charitable giving, political leanings, sensitivity to issues of contemporary interest, level of involvement in matters of work, hobbies, interests, entertainment and relational status: married, single, cohabitating, with children, and other relational matters. Friends who speak other languages or a statement indicating that the user speaks another language may invite the use of linguistic subtleties that might be lost on a broader audience.

Privately provided personal data 410f, different than publically sourced relational data 410e, may be solicited and optionally kept in a database that is secure and only accessible to the user. In this example, it is intended that user provided data will be more candid as the user will be more open if the user knows that the data will remain private and secure. This would be especially so in matters of health and disease, relationships, fears, and other factors. The manner of collecting data may be done by showing clips and asking for preferences. The use of learning neural networks (well understood in the art, see for example, U.S. Pat. Nos. 5,572,628 and 5,067,164 both to Denker et al.)—where commonalities may be deduced and the system may learn the tastes of the user and tailor content to match the user's preferences, whether latent or overt—may be employed to aid in the collection of data.

Privately Provided Relations Data 410g may include preferences in friends, spouses, relatives, and others. In this case the relational data may be used to tailor the hero to comport, in temperament and in some cases appearance, with the user's tastes. In addition, a villain may be made more villainous by understanding and capitalizing on preconceived notions of what a villain looks like. For instance, if a user is afraid of insects, the villain may make a comment of how insects are his best friend and how they seem to like him. Love interests may be tailored to have hair, stature, etc. modified to comport with a user's preconceived notions of desirability. With the aid of post-production techniques, hair and eye color may be altered after the fact. Similarly, a director may choose, for various reasons to deliberately challenge a user's stereotype to obtain greater viewing interest from the user.

Privately Provided Taste Data 410h may range from taste in relations, to taste in locations, language, violence (e.g., graphic, silhouette, exaggerated), courting rituals, promiscuity, willingness to suspend disbelief for a spectacular explosion, desire to have deeper philosophical issues addressed, for example, betrayal might warrant a more thorough development of other factors. In other cases dialog and plot may be sacrificed for raw content. Some users may have a taste for more subtlety delivered themes or information, while others may choose a more direct approach.

Learned Data 410i may be data that may be learned based on user behavior while watching the content. Content that is shared, comments accompanying the shared content, and word choices in the comments provided by the user may also inform vocabulary of the person sharing, and as such, different vocabulary may be included. Familiarity with esoteric concepts may allow for their inclusion, for example, a stereoscopic viewer is shown on the desk, as opposed to a plasma ball.

Observed data 410j may be based on the number of comments and nature of comments or other indicia of approval or disapproval and that may be used to tailor content. In addition, a viewer's actual image may be captured while viewing the media content, factors such as laughing, swearing, or carrying on a conversation while watching may all be used to gauge interest in the content. For example, the frequency with which an activation is attempted (rapid attempts to fast forward, pause, replay, etc., may serve to inform the mental state of the user. If the viewing device is moving (train, plane, etc.) episode length may be altered based on predicted duration as contemplated by prior observed trips on the same (or similar) route.

In operation one embodiment of the media content customization system may customize content for the user or viewer, where the customization is done based on, for example, a set of five separate factors. Factors influence, in the simplest embodiment, a single sensed stimuli. So looking at the mood factor, using respiration, pulse, pupil dilation (adjusted for ambient light) rate of pupil dilation change, speech patterns, including speed (fast or slow), and volume, as well as, optionally, other factors, the tempo of the stimuli may be altered. This may simply result in the change of tempo of music and the addition or deletion of scenes. A slower mood may include additional plot building and more subtle plot points, while a faster, or more upbeat mood, may opt for less subtlety, that is, making explicit what may have been left implicit, as with a voice over or other visual or audio content. Volume may be adjusted, and film speed may be accelerated. Such acceleration may be limited to certain scenes, for example, chases, fights, or other actions. Similarly a slower mood may include additional content and dialog or accompanying music. In one embodiment, these factors may be collected via a set of sensors, for example, biometric sensors, that may monitor vitals and behaviors of the user or viewer.

In the case of fixed factors such as gender or gender identification, content may be customized to validate or challenge traditional notions or stereotypes. For instance, a fight scene may be altered by playing a ballad and framing the fight as a noble gesture to protect the honor of an insulted maiden or as a testosterone fueled, alcohol induced test of virility. Similarly, the viewer's eye color (or desired eye color) may produce a hero or heroine whose eye color is displayed in a close-up and be different based on viewer taste. Also, sexual orientation may inform love interests and radically change the outcome of a viewing based on exceptionally brief sequences coupled with ambiguous dialog and footage. Race, racial history, and ethnicity along with associated experiences may be provided, which might include a passing reference to an obscure ethnic holiday, use of an esoteric term understood only by the race that created it (Yiddish expressions, a reference to speaking in Gullah, or playing “outlawed tunes” on the bagpipe). There are many subtle nuances in speech and music which may create a sense of community with the viewer. These nuances are powerful because they are largely absent from mainstream media or movies, and are missed by the vast majority of viewers when they do appear.

Another area of customization may be based on a viewer having a permanent disability. Stories that might be readily altered to include a quote or small deed from a person with a disability may change the entire tenor of a production. In addition, content may be customized to cater to the viewpoint of the handicapped. Such as recognizing that a wheelchair bound individual may very often walk, even if in a significantly impeded way. Customizing content to incorporate the city or place of birth of a hero or villain may create additional connections with viewers. For instance, a viewer born in Sicily, Boston, Dallas (or anywhere in Texas for that matter) or West Virginia might form a connection with an on screen character by virtue of that character's place of birth. This is especially true in the case when the characteristics ascribed to the place of birth are similar, for example, rugged, hard-working, independent, fierce, etc. Like the place of birth, places associated with one's childhood may be instrumental in allowing a person to associate with a character. And again, many of the characteristics would be attributable to more than a single location, so even subtle changes such as referring to a carbonated beverage as “pop” or “soda.” These subtle changes allow the entire production to have a different feel.

Travel may cause a person to appreciate a scene of the Pantheon, something that another viewer would gloss over. A scene on Pacific Coast Highway might include a background showing the “big rock,” something that a local would know and appreciate but would be unnoticed by another viewer. Even a still shot showing the landmark may create the illusion that the actors are at that location. Showing a freeway exit or water tank may create, in the viewer, a sense that an event is occurring in a familiar venue. Religious experiences, such as weddings, Bar Mitzvahs, or the like, as a child or youth, or even presently, may be customized to the viewer. Again, the viewer need not see an extensive amount of footage to conclude that the show is closely tied to the viewer. In the case of a cancer survivor, or a person having a terminal condition, the content may be tailored to encourage, uplift, or be sensitive to their situation. In some embodiments, the importance of the event to the viewer would enter the calculus as to how much attention would be ascribed to the experience.

In general, such examples shape a person's life, seminal events that are recalled both because memorable and because significant in alteration of life may all be added to the presentation to customize content. Growing up in a low income area may cause a resident to view authority figures differently than a person growing up in a high income area, even if in both cases the authority figure is magnanimous, kind, and honest. The viewer from Compton may view the figure with distrust and a second person might make a cameo appearance validating the authority's statement, or perhaps questioning it.

Factors affecting the customization of media content may also be categorized as according to the follow examples:

Quasi fixed factors may include things that may remain constant throughout life but may also change. This category differs from fixed factors in that it may change, and differs from variable in that it may not change.
Quasi fixed factors such as weight, struggles with weight gain and weight loss may figure prominently into allowing a viewer to bond with a figure or character in the presentation, for example, a lingering shot on a piece of pie, the decision to skip dessert, the adding of ice cream to a shopping cart, etc., may all play a role in this bonding experience. In the same way, fitness level may be portrayed, the agony of an injury precluding an active person from being able to run, the abuse suffered by an overweight person as he parks as near as possible to the store and patrons are heard to say park at the other side of the lot.

The experiences of a parent with a living child, even if fully grown will continue to color the activities, perspectives, and concerns of a viewer. This may take the form of content that explicitly addresses the state of being a parent or takes into account that the parent is—by implicit or explicit statement—watching with their five year old child.

Incorporating hobbies, sports teams, preferred foods, religion/faith, political leanings, familiarity with historical figures (real or fictional), all allow a viewer to become more engaged in a presentation. For instance, the appearance of a bumper sticker, refrigerator magnet, etc. may help the viewer like or dislike a character based on the viewer's known predilection for causes, candidates, or issues.

Catering to a user's taste for speed, adventure, or lack of impulse control (gambling, substance use/abuse) may allow a user to bond with or view with disfavor a character. Mocking a type of employment, for example, disliking lumbers/lawyers/police officers, followed by a phase of enlightenment may provide a viewer with a connection to the hero or villain. Struggling with cancer, serious injury or disease with significant convalescence all may lend themselves to sensitivity thoughtfulness or encouragement. This may include not just customizing content to include a conversation about conquering cancer or disease but about dealing with the emotional toll such things take on the body.

Living arrangements, roommates, married/cohabitation status, living with parents or living with adult kids all provide fertile ground to explore human dynamics. In a subtle distinction a cohabitant may be a lover, a relative, or a spouse. A recurring motif, present or absent, may cement the nature of the relationship.

Quasi variable is another factor that may include the viewer's location of current residence (city, country, high crime/low crime multi-unit standalone), where for example, the place of employment may color content and delivery rate. The length of a commute may also cover duration of episodes and determine when the episodes are pushed to the viewing device. The manner in which commute is made, via car, ground transit/marine, or flight might color the time and duration of pushed episodes. Position of employment, either by job description generally or by role filled: management, white collar, blue collar may be taken into consideration. Within the employment, content may be tailored specifically to trial lawyer, ER doctor, deep sea fisherman, over the road trucker, retail repair tech or someone romanticizing one of these positions. In addition, content may be pushed in relation to trial schedule, working hours, scheduled flights, or commute times. For example, a new episode may not be pushed to the device of the viewer if based on their schedule, they are working; however, there may be more motivation to push new episodes if it is known that the viewer is on break, in between shifts, or commuting on public transportation which may allow them to watch newly released content immediately. Additionally, the type of content may be tailored so as to address and be based on where the viewer may be located, for example, if the viewer is on a break at work or in a crowded commuter train, explicit content may be left out and the content may be determined so as to provide light entertainment—as opposed to ones that require thinking or engaging the emotions of the viewer—thereby providing a relaxing mood. Although quasi variable factors are likely to change they need not.

Variable factors may allow content to be customized. For instance, pregnancy, a variable factor might result in content that is specifically altered to excise brutality, rape, or murder of pregnant women or of human beings in general. It may also limit exposure to gratuitous violence or other content. The expunging of the certain content that may not be appropriate for the viewer may be in accordance with the director's wishes and provide an opportunity to, for example, not show certain scenes during the months the viewer is pregnant and then go back to being based on other factors once it is known that the pregnancy is over. Similarly, if a viewer is on vacation, content may be customized to cater to the vacation destination or activities. If on school break/spring break the content may be customized to the mood of the times. During final exams, content related to encouragement, perseverance, and the need for persistence may be included. As another example, at the collegiate or high school level, the institution name, or a variant of it, such as a nickname, may be included. A period of temporary employment or unemployment may result in content related to the humor of the summer jobs or the reality of an ever changing job market and the value of—and romance of—going back to school. Fluctuations in health or alternatively, the presence of a health problem may influence content to be more complete in development of plot and characters as well as pushing additional content. The diseases in this factor are contemplated to be the flu, broken bone, or other non-permanent injuries. A person in the throes of a new relationship may have customized content including the excitement of seeing everything as magnificent. Travel may also be an occasion to deliver content that includes language, sights, sounds and foods of the destination, whether it is a US State or a foreign country.

In the short term mood as determined by eye dilation, pulse deviation, volume sound associated with impact on keypad, frequency with which the same key is struck, speech patterns—loud, soft, or fast slow—may all be used to customize content. The location of viewing—whether the viewer is in motion, is at work, or is at an airport—may all be considered. In the case of an airport, or area that is likely to have limited internet access, content may be downloaded and delivered based solely on locally provided information tied to database stored information that is resident on the viewing device. That is, the factors may be limited based on the available information and or may be altered dependent on how much information may be obtained. Consideration of the time of viewing, i.e., after work, prior to work, near end of day, near beginning of day all may play a role in determining how the content is customized. Evening viewing, while in the home may be less restricted than viewing that is done at work (between assignments . . . of course).

The state of the user, whether active or passive, as determined by adjusting volume, marking positions, as for points or revisiting for subsequent viewing, may also be significant in amount and contents of delivered material. If the user is viewing content on a portable viewing device, other information such as the angle the device is being held may be obtained, for example, via a combination of accelerometers and gyroscopes. That is, if the device is being held upside down, it may indicate that the user may be lying down and holding the device over their head, and accordingly more relaxing material or content may be desired for viewing. Additionally, the exemplary electronic measuring devices may help determine orientation, velocity, or gravitational forces on the device to decipher detailed information related to the state of the user.

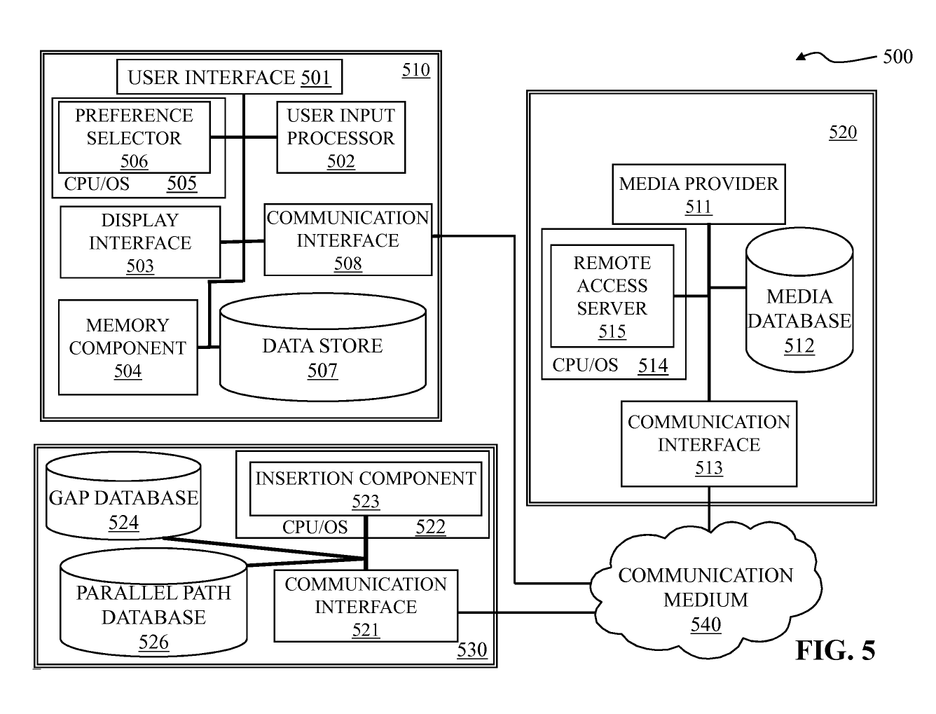

FIG. 5 illustrates an exemplary embodiment of FIG. 1 in greater detail where the networked system 500 comprises a first computing device 510, a second computing device 520, and a third computing device 530, where the computing devices 510, 520, 530 are networked via a communication medium 540. As an exemplary client node, the first computing device 510 is illustrated as having a user interface 501, a user input processor 502, a display interface 503, a memory component 504, and a central processing unit (CPU) 505 having an operating system (OS) configured to host a preference selector controller 506. In some embodiments, a data store 507 may be present to store the one or more media content files received by the computing device 510 via the communication interface 508. As an exemplary server node, the second computing device 520 is illustrated as having an optional media provider component 511, a media database 512, a communication interface 513, and a CPU 514 having an OS configured to host a remote access server 515. As an optional exemplary server node, the third computing device 530 is illustrated as having a communication interface 521, a CPU 522 having an OS configured to host a server and an insertion component 523 configured to access a set of data stores, e.g., gap database 524 and parallel path database 526, for remote access to computing nodes responsive to one or more communications from the computing device 510. In an exemplary embodiment, the first computing device 510, e.g., a client, may request media content from the second computing device 520, e.g., a server, where the media content being requested may comprise a set of gaps that may be filled by the insertion component 523 of the third computing device 530, e.g., another server, where the third computing device 530 may also be used for remote storing of the media content that may be customized to the user or viewer based on information gathered that is associated with the user or viewer. In this exemplary embodiment, a specified amount of content media may be embedded into the file by the second computing device 520, i.e., the content provider, in the encoder settings and may be supported by additional settings required by the first computing device 510. The first computing device 510 may then, based on the user input collected by the user input processor 502 use the preference selector controller 506 to determine a set of custom media content received from the gap database 524 or parallel path database 526 to be inserted in the media content received from the media provider 511. Optionally, the received content may be downloaded to a physical storage, e.g., data store 507, on the first computing device 520 for a progressive download feature.

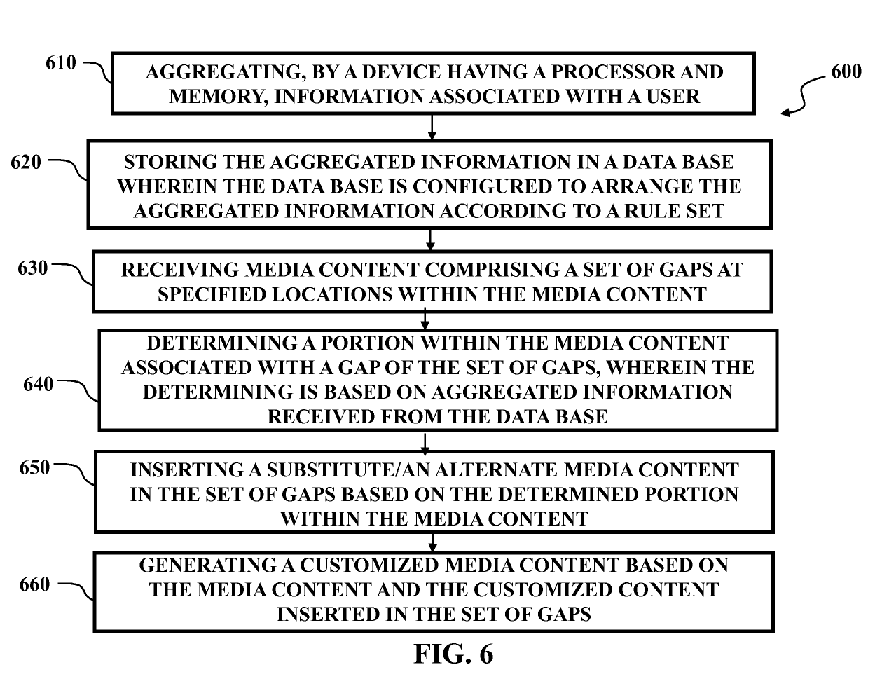

FIG. 6 is a flowchart of an exemplary content media customization device 600. The method depicted in the diagram includes the steps of: (a) aggregating, by a device having a processor and memory, information associated with a user (step 610); (b) storing the aggregated information in a data base wherein the data base is configured to arrange the aggregated information according to a rule set (step 620); (c) receiving media content comprising a set of gaps at specified locations within the media content (step 630); (d) determining a portion within the media content associated with a gap of the set of gaps, wherein the determining is based on aggregated information received from the data base (step 640); (e) inserting a substitute or an alternate media content in the set of gaps based on the determined portion within the media content (step 650); and (f) generating a customized media content based on the media content and the customized content inserted in the set of gaps (step 660). Optionally, the information associated with the user may comprise information related to viewer preferences. In addition, the aggregating of information associated with a user may be on a continual basis.

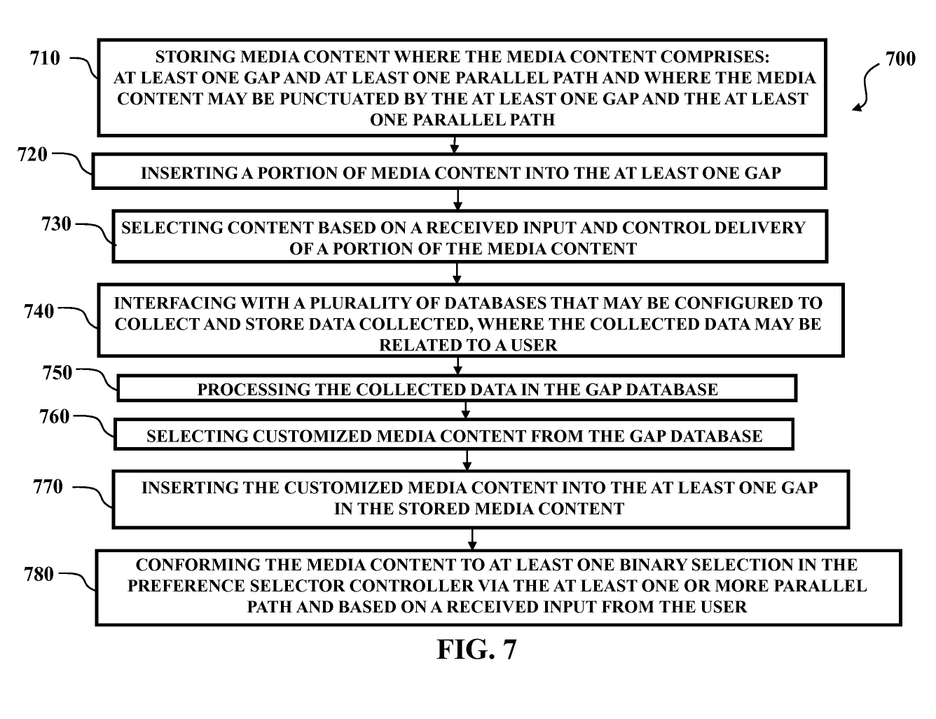

FIG. 7 is a flowchart of an exemplary system environment of a system configured to customize media content, where the system may comprise: a media database; a gap database; a parallel path database; an insertion component comprising a processor and memory; and a preference selector controller comprising a processor and memory. The method depicted in the diagram includes the steps of: (a) storing, by the media database, media content where the media content comprises at least one gap and at least one parallel path and where the media content may be punctuated by the at least one gap and the at least one parallel path (step 710); (b) inserting, by the insertion component, a portion of media content into the at least one gap (step 720); (c) selecting, by the preference selector controller, content based on a received input and control delivery of a portion of the media content (step 730); (d) interfacing, by the gap database, on a periodical basis, with a plurality of databases that may be configured to collect and store data collected, where the collected data may be related to a user (step 740); (e) processing, by the insertion component, the collected data in the gap database (step 750); (f) selecting, by the insertion component, customized media content from the gap database (step 760); (g) inserting, by the insertion component, the customized media content into the at least one gap in the stored media content (step 770); and (h) conforming, by the preference selector controller, the media content to at least one binary selection in the preference selector controller via the at least one or more parallel path and based on a received input from the user (step 780). In some embodiments, the media content may be punctuated at positions or locations previously marked for interjecting or altering the media content.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. It is contemplated that various combinations and/or sub-combinations of the specific features, systems, methods, and aspects of the above embodiments may be made and still fall within the scope of the invention. Accordingly, it should be understood that various features and aspects of the disclosed embodiments may be combined with or substituted for one another in order to form varying modes of the disclosed invention. Further it is intended that the scope of the present invention herein disclosed by way of examples should not be limited by the particular disclosed embodiments described above.

What is claimed is:

1. A system configured to customize media content, the system comprising:
a media database;
a gap database;
a parallel path database;
an insertion component comprising a processor and memory; and
a preference selector controller comprising a processor and memory;
wherein the media database is operatively interfaced with the gap database, and
the insertion component operatively interconnects the gap database and the media database; and the parallel path database operatively interconnects the preference selector controller with the media database;
wherein the media database is configured to store media content, and the stored media content comprises at least one gap and at least one parallel path and wherein the media content is punctuated by the at least one gap and the at least one parallel path;
wherein the insertion component is configured to insert a portion of media content into the at least one gap;
wherein the preference selector controller is configured to select content based on a received input and control delivery of a portion of the media content;
wherein the gap database is configured to periodically operatively interface with a plurality of databases that are configured to collect and store data collected wherein the collected data is related to a user;
wherein the insertion component is configured to: process the collected data in the gap database, select customized media content from the gap database, and insert the customized media content into the at least one gap in the stored media content; and
wherein the preference selector controller is configured to conform the media content to at least one binary selection in the preference selector controller via the at least one parallel path and based on a received input from the user.

2. The system of claim 1 further comprising a media content viewing component configured to display the customized media content based on the insertion component and the preference selector controller.

3. The system of claim 1 further comprising a chronological capture component configured to capture a time that the portion of media content is inserted, and a time that media content is conformed based on the received input, wherein the chronological capture component further comprises:
a position determining component including at least one of:
at least one terrestrially based signal,
a satellite based signal, and
a terrestrial signal originating with contextual data;
a database configured to capture and record the time that the portion of the media content was inserted in the at least one gap, when the media content was conformed to the at least one parallel path; and
a user interface monitoring component configured to monitor activity occurring at a user interface.

4. The system of claim 3 wherein the terrestrial signal originating with contextual data includes determining location by comparing an electromagnetic radiation signal received from a known source to determine a location.

5. The system of claim 3 wherein the user interface monitoring component is configured to monitor activity occurring at a user interface, comprising: the frequency that a specific key is struck; and patterns in which keys are struck.

6. The system of claim 3 further comprising: a data record module that records positional data and access data, access termination data, and further comprises a transmission component that transmits the recorded positional data.

7. A device comprising:
a media content determining component comprising a processor and addressable memory, the addressable memory comprising a rule set, and wherein the processor is configured to:
receive media content from a media content database for viewing by a user, wherein the media content comprises a set of one or more gaps and a set of one or more parallel paths;
determine the set of one or more parallel paths based on availability of default content, wherein the default content is determined based on received input from the user;
determine the set of one or more gaps based on availability of custom content, wherein the custom content is determined based on collected information associated with the user; and
generate a customized media content based on the received media content, the determined set of one or more parallel paths, and the determined the set of one or more gaps.

8. The device of claim 7 wherein the default content is determined based on at least one of: add a portion of media content selected from a parallel path database to the media content, and delete a selected portion of the media content.

9. The device of claim 7 wherein the custom content is determined based on at least one of: fixed factors, quasi fixed factors, quasi variable factors, and variable factors.

10. The device of claim 7 wherein the generated customized media content is generated via: if a preference is selected, conform the media content based on the received input from the user, and if information is collected, insert the portion of media content based on the collected information associated with the user.

11. The device of claim 7 wherein the set of one or more gaps is retrieved from a gap database.

12. The device of claim 7 wherein the set of one or more parallel paths is retrieved from a parallel path database.

13. The device of claim 7 wherein a portion of the media content is temporarily removed from the media content based on input from a user, and wherein input from the user adds new content to the media content.

14. The device of claim 7 wherein the device is further configured to: aggregate information about the user, and classify the information according to the rule set.

15. The device of claim 7 further configured to create substantially linear media presentations based on the parallel paths and gaps.
